(19) United States
(12) Patent Application Publication
(10) Pub. No.: US 2008/0186237 A1
(43) Pub. Date: Aug. 7, 2008

(54) Microstrip Antenna

(76) Inventor: Masato Tanaka, Tokyo (JP)

Correspondence Address: BUTZEL LONG;IP DOCKETING DEPT, 350 SOUTH MAIN STREET, SUITE 300, ANN ARBOR, MI, 48104, US

(21) Appl. No.: 11/886,383

(22) PCT Filed: Mar. 14, 2006
(86) PCT No.: PCT/JP06/04986

§ 371 Date: Sep. 14, 2007

(30) Foreign Application Priority Data
Mar. 14, 2005 (JP) 2005-070858

(51) Int. Cl. H01Q 9/04; H01Q 1/38

(52) U.S. Cl. 343/700 MS

(57) ABSTRACT

A microstrip antenna comprising a dielectric substrate, a ground conductor provided on one surface thereof, a radiation conductor provided on the other surface and having an area smaller than that of the ground conductor, wherein generally flat electric circuit part having a ground surface is arranged on the surface of the radiation conductor, the ground surface of the electric circuit part is connected with the radiation conductor, and the plus terminal of the electric circuit part is inserted through a hole made through the radiation conductor, passed through the dielectric substrate out of contact with the radiation conductor, and connected with the ground conductor. Consequently, the microstrip antenna can be installed stably on any article without being impeded by the electric circuit part even if the electric circuit part is connected substantially directly and projected.

### TECHNICAL FIELD

The present invention relates to the configuration of a microstrip antenna.

### BACKGROUND ART

Microstrip antennas are characterized in that the antenna is thin and light, the configuration is simple, it is easy to radiate circular polarized waves, and the gain is relatively high.

Because of these characteristics, microstrip antennas are widely used as antennas for mobile terminals mounted in automobiles and the like, receiving antennas for satellite broadcasts, on-board antennas for satellites and the like.

FIGS. 1 and 2 are a front diagram and a cross sectional side diagram schematically showing a conventional microstrip antenna.

A ground conductor (12) is pasted on one surface of a dielectric substrate (11) in plate form, and a radiation conductor (13) of which the area is smaller than that of the ground conductor (12) is pasted on the other surface.

In the case where a compact electric circuit part (20), such as a wireless IC chip, is connected directly to this without using a coaxial cable or the like, the electric circuit part (20) is placed on the ground conductor (12) side, and the ground surface (21) of the minus side of the electric circuit part (20) is connected to the ground conductor (12) of the microstrip antenna. In addition, the plus terminal (22) of the electric circuit part (20), which makes a pair with the ground surface (21) and transmits electric signals and microwaves, is inserted through a hole (14) provided in the ground conductor (12), and thus, passes through the dielectric substrate (11) out of contact with the ground conductor (12), and is connected to a radiation conductor (13).

FIGS. 3 and 4 are also a front diagram and a cross sectional side diagram schematically showing a conventional microstrip antenna.

The ground surface of the electric circuit part (20) in this example is insulated, and the electric circuit part is provided with a ground terminal (23) instead of the ground surface (21) shown in FIG. 1.

In this case also, as in the above described example, the electric circuit part (20) is placed on the ground conductor (12) side. In addition, the ground terminal (23) of the electric circuit part (20) is connected to the ground conductor (12) of the microstrip antenna.

The microstrip antenna radiates radio waves from the radiation conductor (13) side, and therefore, when attached to an article, the ground conductor (12) faces the article.

Therefore, according to the conventional art, in the case where a microstrip antenna to which an electric circuit part (20) is substantially directly connected is installed, the electric circuit part (20) protrudes and becomes a hindrance, and therefore, a problem arises, such that it is difficult to provide the microstrip antenna on a hard article, such as of metal.

The present inventor cites Patent Documents 1 to 4 relating to microstrip antennas.

However, the above described problem is not solved.

Patent Document 1: Japanese Patent Application Laid-open (JP-A) No. 7-15230 “Microstrip Antenna with Solar Battery”

Patent Document 2: JP-A NO. 2000-82915 “Antenna Apparatus”

Patent Document 3: JP-A No. 2003-258539 “Microstrip Antenna”

Patent Document 4: JP-A No. 2004-112057 “Microstrip Antenna”

### DISCLOSURE OF THE INVENTION

Therefore, an object of the present invention is to provide a microstrip antenna which can be installed stably on any article without being impeded by the electric circuit part even if the electric circuit part is connected substantially directly and projected.

In order to solve the above described problem, the microstrip antenna of the present invention has the following configuration.

That is to say, a microstrip antenna having a dielectric substrate, a ground conductor provided on one surface thereof, a radiation conductor provided on the other surface and having an area which is smaller than that of the ground conductor, is characterized in that a generally flat electric circuit part having a ground surface is provided on the surface of the radiation conductor, the ground surface of the electric circuit part is connected to the radiation conductor, and the plus terminal of the electric circuit part is inserted through a hole provided in the radiation conductor, passes through the dielectric substrate out of contact with the radiation conductor, and is connected to the ground conductor.

In addition, in a microstrip antenna having a dielectric substrate, a ground conductor provided on one surface thereof, a radiation conductor provided on the other surface and having an area which is smaller than that of the ground conductor, a generally flat electric circuit part having no ground surface may be provided on the surface of the radiation conductor in such a manner as to be insulated from the radiation conductor, the ground terminal of the electric circuit part may be connected to the radiation conductor, and the plus terminal of the electric circuit part may be inserted through a hole provided in the radiation conductor, pass through the dielectric substrate out of contact with the radiation conductor, and be connected to the ground conductor.

In a microstrip antenna having a dielectric substrate, a ground conductor provided on one surface thereof, a radiation conductor provided on the other surface and having an area which is smaller than that of the ground conductor,a generally flat electric circuit part having no ground surface may be provided on the surface of the radiation conductor in such a manner as to be insulated from the radiation conductor, the plus terminal of the electric circuit part may be connected to the radiation conductor, and the ground terminal of the electric circuit part maybe inserted through a hole provided in the radiation conductor, pass through the dielectric substrate out of contact with the radiation conductor, and be connected to the ground conductor.

Here, it is preferable for the hole in the radiation conductor through which a terminal of the electric circuit part is inserted to be in such a location that the impedance of the microstrip antenna generally coincides with the impedance of the electric circuit part.

A matching circuit for matching the impedance of the microstrip antenna and the impedance of the electric circuit part may be connected to the electric circuit part.

That is to say, a matching circuit for lowering the impedance is connected to the electric circuit part so that the impedance of the microstrip antenna and the impedance of the electric circuit part can be made the same approximately, even in the case where the impedance of the electric circuit part is greater than the impedance of the antenna at the edge of the radiation conductor. In addition, a matching circuit may be provided so that the impedance of the electric circuit part can be approximately matched with the impedance at a suitable point inside the radiation conductor in the antenna even in the case where the impedance of the electric circuit part is smaller than the impedance of the antenna at the edge of the radiation conductor.

The dielectric substrate maybe made of cloth and likewise, and the ground conductor and the radiation conductor may be made of a conductive cloth so that they can be applied to a microstrip antenna made of cloth.

Likewise, the dielectric substrate may be made of a felt fabric, and the ground conductor and the radiation conductor may be made of a conductive cloth so that they can be applied to a microstrip antenna made of cloth.

### EFFECT OF THE INVENTION

In the microstrip antenna according to the present invention, the electric circuit part is provided on the radiation conductor side, and therefore, even in the case where the electric circuit part protrudes, the microstrip antenna can be installed stably on any article without being impeded by the electric circuit part.

### BRIEF DESCRIPTION OF THE DRAWINGS

FIG. 1 is a front diagram schematically showing a conventional microstrip antenna;

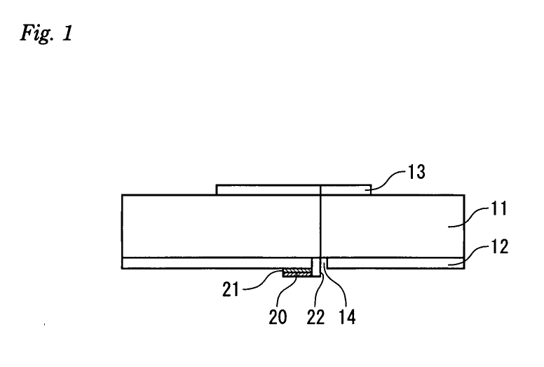

FIG. 2 is a cross sectional side diagram showing the same;

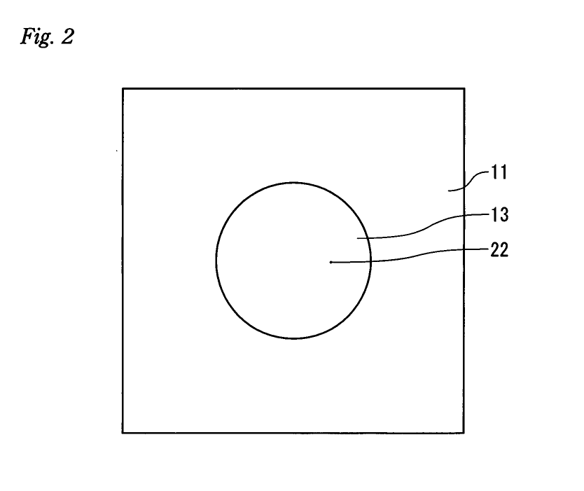

FIG. 3 is a front diagram schematically showing another conventional microstrip antenna;

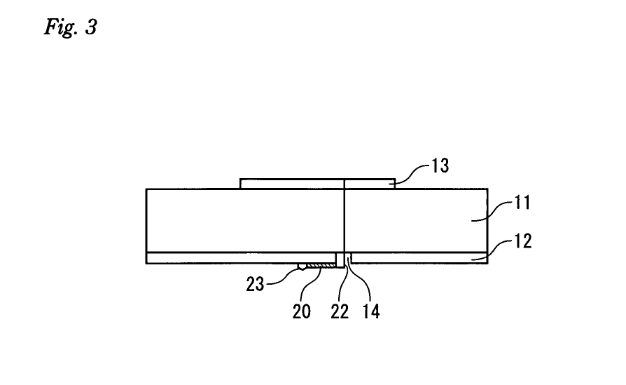

FIG. 4 is a cross sectional side diagram showing the same;

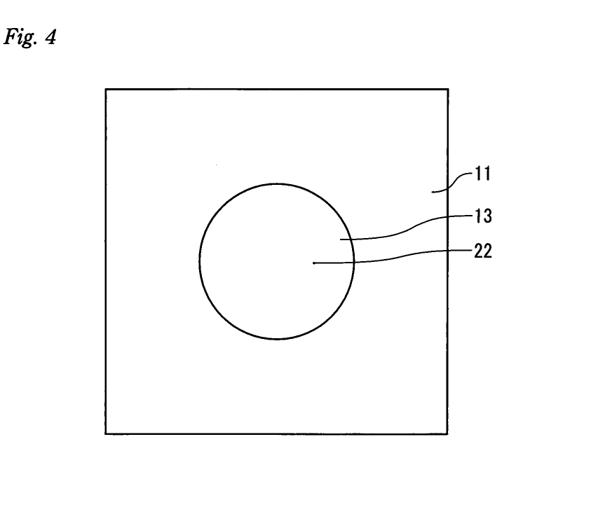

FIG. 5 is a front diagram schematically showing a microstrip antenna according to the present invention;

FIG. 6 is a cross sectional side diagram showing the same;

FIG. 7 is a front diagram schematically showing another microstrip antenna according to the present invention;

FIG. 8 is a cross sectional side diagram showing the same;

FIG. 9 is a front diagram schematically showing still another microstrip antenna according to the present invention;

FIG. 10 is a cross sectional side diagram showing the same;

FIG. 11 is a front diagram schematically showing yet another microstrip antenna according to the present invention;

FIG. 12 is a cross sectional side diagram showing the same;

FIG. 13 is a front diagram schematically showing another microstrip antenna according to the present invention; and

FIG. 14 is a cross sectional side diagram showing the same.

### BEST MODE FOR CARRYING OUT THE INVENTION

In the following, the embodiments of the present invention are described in reference to the drawings.

Here, conventional, publicly known technology, such as that in Patent Documents 1 to 4 by the present inventor, can be applied to the embodiments, of which appropriate modifications can be made in terms of the details of the configuration and the design, as long as the gist of the present invention is not deviated from.

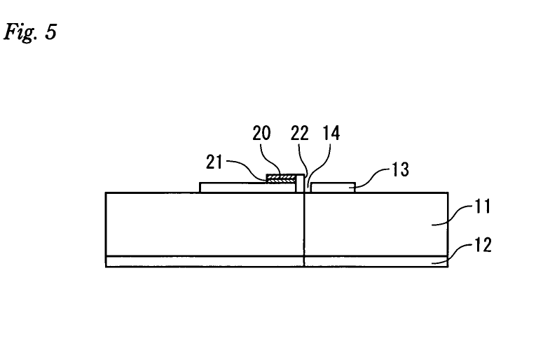

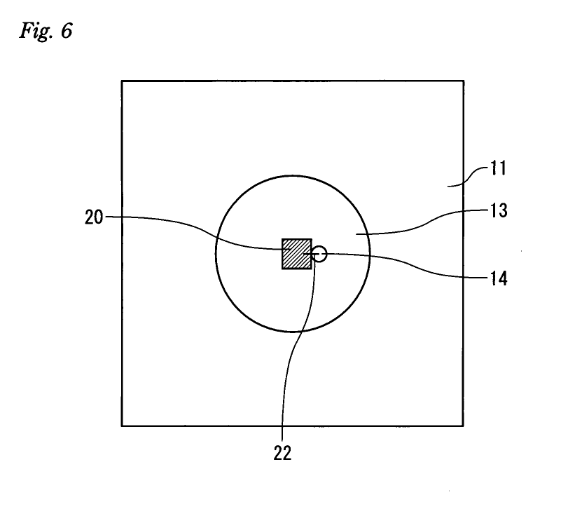

FIGS. 5 and 6 are a front diagram and a cross sectional side diagram showing a microstrip antenna according to one embodiment of the present invention.

The area of a radiation conductor (13) made of a metal plate is smaller than that of a ground conductor (12) made of a metal plate. In addition, the ground conductor (12) and a dielectric substrate (11) have generally the same form and the same area, but it is not necessary for them to be the same.

The dielectric substrate (11), the ground conductor (12) and the radiation conductor (13) are each basically in plate form and not limited to being in disc form, and may be in convex polygonal, thin plate form. A quadrilateral radiation conductor (13) may be combined with a dielectric substrate (11) and ground conductor (12) in disc form, or a radiation conductor (13) in disc form may be combined with a quadrilateral dielectric substrate (11) and ground conductor (12). In the illustrated example, the radiation conductor (13) is in disc form, and the dielectric substrate (11) and the ground conductor (12) are in quadrilateral plate form.

The dielectric substrate (11) and the ground conductor (12) are joined surface to surface, and the radiation conductor (13) is joined generally in the center portion of the dielectric substrate (11) so as not to protrude from the dielectric substrate (12).

As for the joining method, conventional, publicly known adhesion using an adhesive is possible, but the relative dielectric constant may vary when an adhesive is used. In order to prevent this, a method for carrying out an etching process on the two surfaces of the dielectric substrate (11) using the metal plate in the ground conductor (12) and the radiation conductor (13) so that the metal plate is partially peeled is used. The consequence is the same as when the ground conductor (12) and the radiation conductor (13) are pasted to the dielectric substrate (11).

In addition, according to the method for carrying out an etching process, the part of the metal plate remaining after peeling becomes a radiation conductor and the resonant frequency of the microstrip antenna depends on the size of the radiation conductor. Therefore, what part of the metal plate is peeled can be adjusted in order to adjust the antenna frequency.

It is preferable to use a metal having little electric resistance for the metal plate for forming the ground conductor (12) and the radiation conductor (13). Copper, which is relatively inexpensive and has sufficiently little electric resistance, is generally used.

Though different metals may be used for the ground conductor (12) and the radiation conductor (13), generally the same metal is used.

Dielectric materials, such as Teflon®, glass epoxy, polyethylene, ceramic and the like can be used for the dielectric substrate (11), and the greater the relative dielectric constant is, the more the wavelength of the radio wave is shortened inside the dielectric material, and thus, the material can contribute to miniaturization of microstrip antennas. An insulator having a sufficiently small relative dielectric constant may be used, depending on the conditions in terms of the design.

In the case where the dielectric substrate (11) is formed of a cloth or a felt fabric and the ground conductor (12) and the radiation conductor (13) are formed of a conductive cloth, a microstrip antenna made of cloth is gained.

One small through hole (14) is provided vertically in the dielectric substrate (11) to which the ground conductor (12) and the radiation conductor (13) are joined using a machine tool, such as a drill or a gimlet.

The diameter of the hole (14) in the radiation conductor (13) is slightly enlarged by peeling or the like.

The location of the hole (14) becomes a feeding point in the microstrip antenna, and therefore, it is preferable for the location to be such that the impedance of the microstrip antenna becomes approximately the same as the impedance of the electric circuit part (20).

In general, in the case where the radiation conductor (13) of the microstrip antenna is in disc form, the farther toward the outside the feeding point is located from the center of the radiation conductor (13), the higher the impedance becomes. Theoretically, the impedance when the feeding point is at the center is 0Ω and the impedance when the feeding point is at the edge of the radiation conductor (13) is several hundreds of Ω.

In many cases, power is fed to the microstrip antenna through a coaxial cable of 50Ω, and therefore, a location approximately ⅓ of the radius from the center of the radiation conductor (12) can be cited as an example of the location where the impedance becomes approximately 50Ω.

A desired generally flat electric circuit part (20), for example a wireless IC chip, is provided on the surface of the radiation conductor (13).

The illustrated electric circuit part (20) is provided with a ground surface (21). This ground surface (21) is joined to the radiation conductor (13) in accordance with the same method as above, and thus, the electric circuit part (20) and the radiation conductor (13) are electrically connected.

The plus terminal (22) of the electric circuit part (20) is inserted through the hole (14) provided in the radiation conductor (13), passes through the dielectric substrate (11) out of contact with the radiation conductor (13), and is connected to the ground conductor (12). In the hole (14), the dielectric substrate (11) and the ground conductor (12) may make contact with the plus terminal (22).

It is preferable for the length of the plus terminal (22) to be such that the end portion lightly protrudes from the ground conductor (12). This protruding end portion and the hole (14) are coated with solder or the like.

A method other than soldering may be used, as long as the plus terminal (22) and the ground conductor (12) are connected in such a state as to be conductive. For example, a method for adhesion according to which a coating part in lid form made of the same metal as the ground conductor (12) is attached so that it makes contact with the plus terminal (22) and the ground conductor (12) may be used.

When a voltage is applied between the radiation conductor (13) and the ground conductor (12) in the microstrip antenna having the configuration described above, a leakage electrical field is generated in the vicinity of the edge portion of the radiation conductor (13), and from there, spherical radio waves are radiated toward the space on the radiation conductor (13) side.

According to the present invention, the characteristics of the microstrip antenna are examined, and as described above, the electric circuit part (20) is placed on the radiation conductor (13) side and the plus terminal (22) of the electric circuit part (20) passes through the dielectric substrate (11) and is connected to the ground conductor (12), unlike in the conventional art.

In the microstrip antenna, even in the case where a generally planar part of such a size as not to protrude from the radiation conductor (13) is provided on the surface of the radiation conductor, the radiation characteristics of the antenna are not greatly affected.

In addition, even in the case where the plus terminal (22) is connected to the ground conductor (12) and the ground surface (21) or the ground terminal is connected to the radiation conductor (13), the radiation characteristics are not greatly affected.

These two points are used in the present invention, and thus, the above described configuration is adopted.

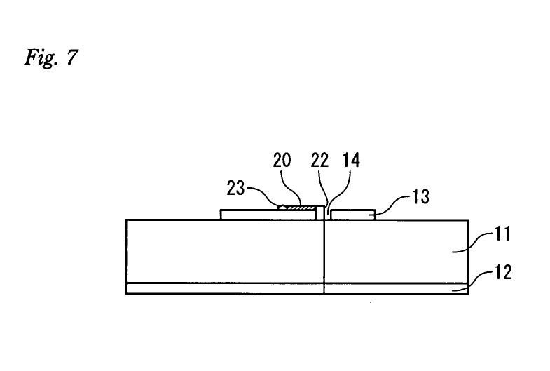

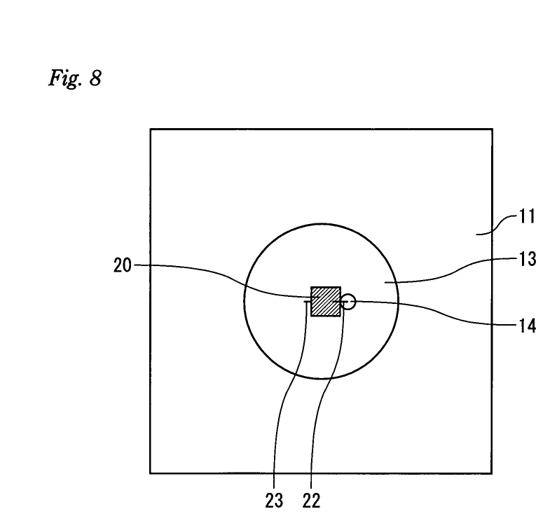

FIGS. 7 and 8 are a front diagram and a cross sectional side diagram showing another embodiment.

An electric circuit part (20) in the present embodiment has an insulated ground surface and is provided with a ground terminal (23) instead of the ground surface (21) shown in FIG. 5.

In this case also, the electric circuit part (20) is placed on the radiation conductor (13) side, the ground terminal (23) of the electric circuit part (20) is connected to the radiation conductor (13), and the plus terminal (22) of the electric circuit part (20) passes through the dielectric substrate (11) and is connected to the ground conductor (12), and thus, the antenna can be installed stably on any article without being impeded by the protruding electric circuit part (20) and the radiation properties of the antenna being damaged.

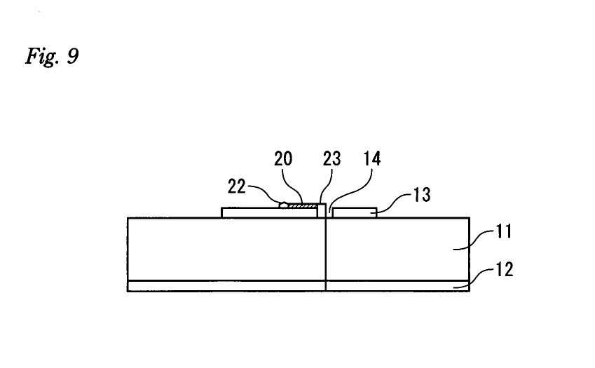

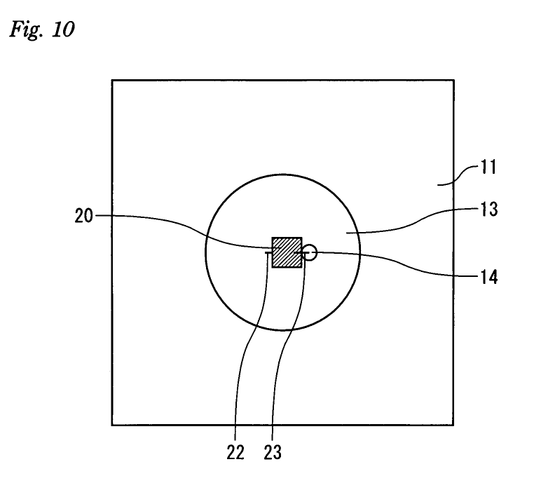

FIGS. 9 and 10 are a front diagram and a cross sectional side diagram showing another embodiment.

In the present embodiment, a ground terminal (23) of an electric circuit part (20) passes through a dielectric substrate (11) and is connected to a ground conductor (12), and a plus terminal (22) is connected to a radiation conductor (13).

In this case also, the electric circuit part (20) is placed on the radiation conductor (13) side, and therefore, the antenna can be installed stably on any article without being impeded by the protruding electric circuit part (20) and the radiation properties of the antenna being damaged.

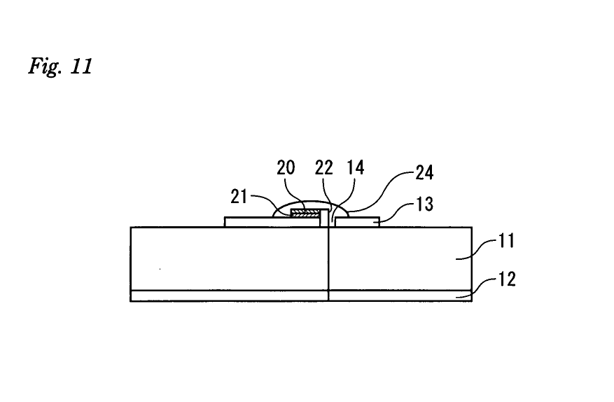

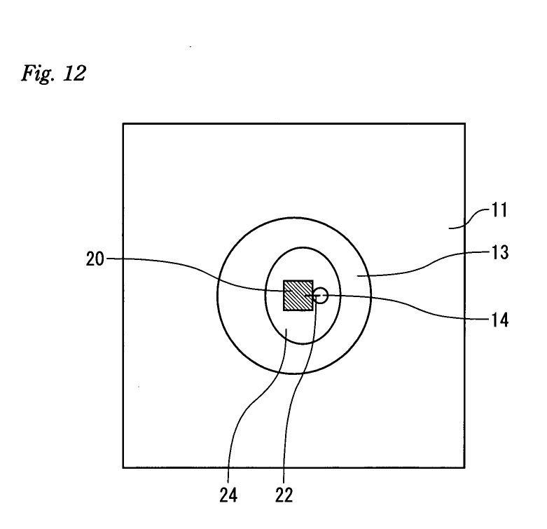

FIGS. 11 and 12 are a front diagram and a cross sectional side diagram showing another embodiment.

In the present embodiment, an insulating mold (24) is added to the embodiment shown in FIGS. 5 and 6.

By using insulating mold (24), the electric circuit part (20) on the radiation conductor (13) is molded together with the terminal (22) with silicone or the like.

Likewise, an insulating mold (24) can also be provided in other embodiments.

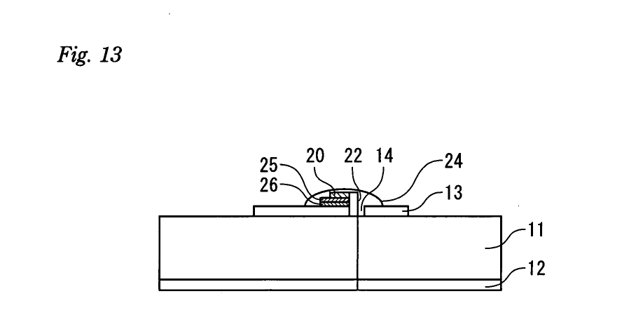

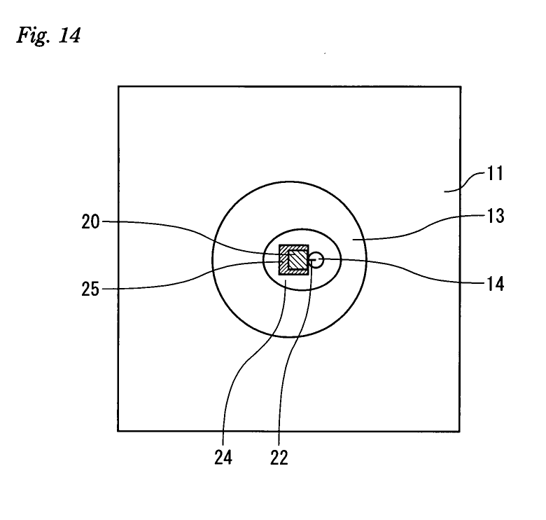

FIGS. 13 and 14 are a front diagram and a cross sectional side diagram showing another embodiment.

In the present embodiment, a matching circuit part (25) is added.

In the case where the impedance of the electric circuit part (20) is greater than the impedance of the antenna at the edge of the radiation conductor (13), a matching circuit part (25) for lowering the impedance of the electric circuit part (20) so that it matches with the impedance of the antenna is provided.

In addition, even in the case where the impedance of the electric circuit part (20) is smaller than the impedance of the antenna at the edge of the radiation conductor (13), a matching circuit part (25) for matching the impedance of the electric circuit part with the impedance of the antenna at a suitable point inside the radiation conductor is provided.

In the illustrated example, the matching circuit part (25) is placed beneath the electric circuit part (20) so that the two are electrically connected. In addition, the ground surface (26) of the matching circuit part (25) is connected to the radiation conductor (13).

Likewise, a matching circuit part (25) can also be provided in other embodiments.

### INDUSTRIAL APPLICABILITY

The microstrip antenna according to the present invention can be stably installed on a hard article, such as metal, without any disadvantages, such as damaging of the radiation properties of the antenna, and therefore, the invention has a wide range of applications and is highly useful in the industry.

1. A microstrip antenna, comprising a dielectric substrate, a ground conductor provided on one surface thereof, a radiation conductor provided on the other surface and having an area that is smaller than that of the ground conductor, characterized in that
a generally flat electric circuit part having a ground surface is provided on a surface of the radiation conductor,
the ground surface of the electric circuit part is connected to the radiation conductor, and
a plus terminal of the electric circuit part is inserted through a hole provided in the radiation conductor and passes through the dielectric substrate out of contact with the radiation conductor, and is connected to the ground conductor.

2. A microstrip antenna, comprising a dielectric substrate, a ground conductor provided on one surface thereof, a radiation conductor provided on the other surface and having an area that is smaller than that of the ground conductor, characterized in that
a generally flat electric circuit part having no ground surface is provided on a surface of the radiation conductor so as to be insulated from the radiation conductor,
a ground terminal of the electric circuit part is connected to the radiation conductor, and
a plus terminal of the electric circuit part is inserted through a hole provided in the radiation conductor and passes through the dielectric substrate out of contact with the radiation conductor, and is connected to the ground conductor.

3. A microstrip antenna, comprising a dielectric substrate, a ground conductor provided on one surface thereof, a radiation conductor provided on the other surface and having an area that is smaller than that of the ground conductor, characterized in that
a generally flat electric circuit part having no ground surface is provided on a surface of the radiation conductor so as to be insulated from the radiation conductor,
a plus terminal of the electric circuit part is connected to the radiation conductor, and
a ground terminal of the electric circuit part is inserted through a hole provided in the radiation conductor and passes through the dielectric substrate out of contact with the radiation conductor, and is connected to the ground conductor.

4. The microstrip antenna according to claim 1, wherein
the hole in the radiation conductor through which the terminal of the electric circuit part is inserted is provided in such a location that the impedance of the microstrip antenna approximately coincides with the impedance of the electric circuit part.

5. The microstrip antenna according to claim 1, wherein
a matching circuit for approximately matching the impedance of the electric circuit part with the impedance of the microstrip antenna is connected to the electric circuit part.

6. The microstrip antenna according to claim 1, wherein
the dielectric substrate is made of cloth and the ground conductor and the radiation conductor are made of conductive cloth.

7. The microstrip antenna according to claim 1, wherein
the dielectric substrate is made of a felt fabric and the ground conductor and the radiation conductor are made of conductive cloth.

8. The microstrip antenna according to claim 2, wherein
the hole in the radiation conductor through which the terminal of the electric circuit part is inserted is provided in such a location that the impedance of the microstrip antenna approximately coincides with the impedance of the electric circuit part.

9. The microstrip antenna according to claim 3, wherein
the hole in the radiation conductor through which the terminal of the electric circuit part is inserted is provided in such a location that the impedance of the microstrip antenna approximately coincides with the impedance of the electric circuit part.

10. The microstrip antenna according to claim 2, wherein
a matching circuit for approximately matching the impedance of the electric circuit part with the impedance of the microstrip antenna is connected to the electric circuit part.

11. The microstrip antenna according to claim 3, wherein
a matching circuit for approximately matching the impedance of the electric circuit part with the impedance of the microstrip antenna is connected to the electric circuit part.

12. The microstrip antenna according to claim 4, wherein
a matching circuit for approximately matching the impedance of the electric circuit part with the impedance of the microstrip antenna is connected to the electric circuit part.

13. The microstrip antenna according to claim 2, wherein
the dielectric substrate is made of cloth and the ground conductor and the radiation conductor are made of conductive cloth.

14. The microstrip antenna according to claim 3, wherein
the dielectric substrate is made of cloth and the ground conductor and the radiation conductor are made of conductive cloth.

15. The microstrip antenna according to claim 4, wherein
the dielectric substrate is made of cloth and the ground conductor and the radiation conductor are made of conductive cloth.

16. The microstrip antenna according to claim 5, wherein
the dielectric substrate is made of cloth and the ground conductor and the radiation conductor are made of conductive cloth.

17. The microstrip antenna according to claim 2, wherein
the dielectric substrate is made of a felt fabric and the ground conductor and the radiation conductor are made of conductive cloth.

18. The microstrip antenna according to claim 3, wherein
the dielectric substrate is made of a felt fabric and the ground conductor and the radiation conductor are made of conductive cloth.

19. The microstrip antenna according to claim 4, wherein
the dielectric substrate is made of a felt fabric and the ground conductor and the radiation conductor are made of conductive cloth.

20. The microstrip antenna according to claim 5, wherein
the dielectric substrate is made of a felt fabric and the ground conductor and the radiation conductor are made of conductive cloth.
